(19) United States
(12) Patent Application Publication
(10) Pub. No.: US 2015/0110013 A1
(43) Pub. Date: Apr. 23, 2015

(54) METHOD AND APPARATUS FOR LINK ADAPTATION IN PRECODED MIMO SYSTEMS

(71) Applicants: Yu Zhang, Beijing (CN); Zhennian Sun, Beijing (CN); Gang Wang, Beijing (CN); Ming Lei, Beijing (CN)

(72) Inventors: Yu Zhang, Beijing (CN); Zhennian Sun, Beijing (CN); Gang Wang, Beijing (CN); Ming Lei, Beijing (CN)

(73) Assignee: NEC (CHINA) CO., LTD., Beijing (CN)

(21) Appl. No.: 14/345,125

(22) PCT Filed: Mar. 29, 2012
(86) PCT No.: PCT/CN2012/073237

§ 371 Date: Oct. 17, 2014

(51) Int. Cl. H04L 1/18; H04B 7/04

(52) U.S. Cl. CPC H04L 1/1861; H04B 7/0413
USPC 370/329

(57) ABSTRACT

Embodiments of the invention relate to methods and apparatus for link adaptation in a preceded MIMO system. According to one embodiment, there is provided a method for link adaptation in a precoded MIMO system. The method comprises: receiving first channel quality information γ_{CQI}; with respect to at least one layer r in a plurality of layers in a link; obtaining a Hybrid Automatic Repeat Request (HARQ) scaling factor μᵣ that is associated with a HARQ feedback; and interpreting the first channel quality information γ_{CQI} into second channel quality information \hat{γ}ᵣ based on at least the HARQ scaling factor μᵣ, wherein the second channel quality information \hat{γ}ᵣ is for adapting the at least one layer r in the plurality of layers. According to another embodiment, there is provided an apparatus for link adaptation in a precoded MIMO system.

### FIELD OF THE INVENTION

Embodiments of the present invention generally relate to link adaptation. More particularly, embodiments of the present invention relate to methods and apparatuses for link adaptation in a precoded multiple-input multiple-output (MIMO) system.

### BACKGROUND OF THE INVENTION

In the technical field of wireless communication, channel fading is a fundamental characteristic of a wireless communication channel. Meanwhile, channel fading may be variable over time of the instantaneous conditions of the wireless communication channel. Channel-dependent adaptation of a transmission is one way to handle channel fading. When a channel is in a good state, it is possible to transmit data using a low level of error protection on the channel. In contrast, when the channel is in a bad fading state, a higher level of error protection is necessary, which causes a reduction in the information data rate. The level of error protection may, for example, be varied by changing the modulation format and channel coding rate. In order to maximize the information data rate, the error protection level of the transmission should be adapted to the instantaneous channel conditions. In the wireless communication system, this is often called “link adaptation.”

In a typical wireless communication system, in order to transmit data to a User Equipment (UE), many parameters of the communication channel may be configured by a Base Station (BS). If the parameters are configured to proper ones, date may be transmitted correctly in a reliable manner. Thus, these parameters may be adjusted according to various features during data transmission. In practice, the UE may be able to directly determine the instantaneous channel conditions of the channel, but the BS is not able to do so. Accordingly, in order for the BS to adapt data transmission to the UE, the UE needs to provide feedback to the BS information indicating the quality of the channel.

Typically, the UE indicates the quality of the channel by transmitting one or more scalar quantities known as Channel Quality Indicator (CQI) values, which indicate the quality of a channel for the purpose of describing the channel's ability to support information transfer. For example, a CQI value can indicate a recommended modulation format and code-rate based on channel measurements. For example, the CQI value can be a signal to interference plus noise power ratio (SINR) value computed by the UE based on channel measurements. The CQI may be defined in various manners, for example, the CQI may be represented by a binary code with four bits in the LTE environment. In other words, a value as selected from a group of integers from 0 to 15 may be fed back from the UE for describing the channel's ability to support information transfer. However, in an environment of High Speed Packet Access (HSPA), the CQI may be indicated with five bits. The CQI value from the UE may be adopted in link adaptation. Because performance of a link typically depends on the CQI feedback, the link adaptation system may implement a control loop that aims at meeting the performance target.

In wireless communication systems employing MIMO technology, the communication link may often be represented by a plurality of links, which are called “layers” in the context of the present invention. Each layer may have an individual channel quality or the layers may have the same channel quality. In many MIMO systems, it is possible to adapt the level of error protection on each layer separately. In such a system, it is beneficial to estimate an individual CQI value corresponding to each layer. With this individual CQI indicating quality of each layer, link adaptation may be implemented in a much effective and precious way.

Chinese Patent Application No. 200910222552.6, entitled “Methods and Apparatus for Correcting Channel Quality Information,” filed on Nov. 13, 2009 has disclosed a method of correcting Channel Quality Information. Although it has provided a method of estimating quality in an individual layer of a plurality of layers, delay is introduced in the estimating process. Meanwhile, when the estimating step is implemented at the UE end, the UE should be informed with information relevant to antenna virtualization, which results in a modification at the UE end. Therefore, those methods and apparatuses cannot provide post-equalization SINR when eigen-based TM8 (Transmission Mode 8) is used in LTE TDD system.

### SUMMARY OF THE INVENTION

In view of the foregoing problems in the existing approaches, there is a need in the art to provide a method and apparatus for link adaptation in a precoded multiple-input multiple-output MIMO system.

According to one embodiment of the present invention, there is provided a method for link adaptation in a precoded MIMO system. The method comprises: receiving first channel quality information γ_{CQI}; with respect to at least one layer r in a plurality of layers in a link, obtaining a Hybrid Automatic Repeat Request (HARQ) scaling factor μᵣ that is associated with a HARQ feedback; and interpreting the first channel quality information γ_{CQI} into second channel quality information {circumflex over (ᵣ based on at least the HARQ scaling factor μᵣ, wherein the second channel quality information \hat{γ}ᵣ is for adapting the at least one layer r in the plurality of layers.

According to one embodiment of the present invention, the obtaining the HARQ scaling factor μᵣ that is associated with a HARQ feedback comprises: adjusting the HARQ scaling factor μᵣ for everyone in the plurality of layers in response to a single-layer HARQ feedback being received; and adjusting the HARQ scaling factor μᵣ only for layer r on which a multi-layers HARQ feedback is received in response to the multi-layers HARQ feedback being received.

According to one embodiment of the present invention, the adjusting the HARQ scaling factor μᵣ for everyone in the plurality of layers in response to a single-layer HARQ feedback being received further comprises: increasing the HARQ scaling factor μᵣ for everyone in the plurality of layers in response to a single-layer HARQ ACK being received; and decreasing the HARQ scaling factor μᵣ for everyone in the plurality of layers in response to a single-layer HARQ NACK being received.

According to one embodiment of the present invention, the adjusting the HARQ scaling factor μᵣ only for layer r on which a multi-layers HARQ feedback is received in response to the multi-layers HARQ feedback being received comprises: increasing the HARQ scaling factor μᵣ only for layer r on which a multi-layers HARQ ACK is received in response to the multi-layers HARQ ACK being received; and decreasing the HARQ scaling factor μᵣ only for layer r on which a multi-layers HARQ NACK is received in response to the multi-layers HARQ NACK being received.

According to one embodiment of the present invention, there is provided an apparatus for link adaptation in a precoded MIMO system. The apparatus comprises: a receiving unit configured for receiving first channel quality information γ_{CQI}; an obtaining unit configured for, with respect to at least one layer r in a plurality of layers in a link, obtaining a Hybrid Automatic Repeat Request (HARQ) scaling factor μᵣ that is associated with a HARQ feedback; and an interpreting unit configured for, with respect to at least one layer r in a plurality of layers in a link, interpreting the first channel quality information γ_{CQI} into second channel quality information \hat{γ}ᵣ based on at least the HARQ scaling factor μᵣ, wherein the second channel quality information \hat{γ}ᵣ is for adapting the at least one layer r in the plurality of layers.

According to one embodiment of the present invention, the obtaining unit comprises: a first adjusting unit configured for adjusting the HARQ scaling factor μᵣ for everyone in the plurality of layers in response to a single-layer HARQ feedback being received; and a second adjusting unit configured for adjusting the HARQ scaling factor μᵣ only for layer r on which a multi-layers HARQ feedback is received in response to the multi-layers HARQ feedback being received.

According to one embodiment of the present invention, the first adjusting unit comprises: a first increasing unit configured for increasing the HARQ scaling factor μᵣ for everyone in the plurality of layers in response to a single-layer HARQ ACK being received; and a first decreasing unit configured for decreasing the HARQ scaling factor μᵣ for everyone in the plurality of layers in response to a single-layer HARQ NACK being received.

According to one embodiment of the present invention, the second adjusting unit comprises: a second increasing unit configured for increasing the HARQ scaling factor μᵣ only for layer r on which a multi-layers HARQ ACK is received in response to the multi-layers HARQ ACK being received; and a second decreasing unit configured for decreasing the HARQ scaling factor μᵣ only for layer r on which a multi-layers HARQ NACK is received in response to the multi-layers HARQ NACK being received.

Other features and advantages of the embodiments of the present invention will also be apparent from the following description of specific embodiments when read in conjunction with the accompanying drawings, which illustrate, by way of example, the principles of embodiments of the invention.

### BRIEF DESCRIPTION OF THE DRAWINGS

Embodiments of the invention are presented in the sense of examples and their advantages are explained in greater detail below, with reference to the accompanying drawings, wherein:

FIG. 1 schematically illustrates a block diagram of a wireless communication system in which the methods and apparatuses of the present invention may be implemented;

FIG. 2A schematically illustrates a block diagram of a typical CQI measurement, and FIG. 2B schematically illustrates a block diagram of link adaptation according to one embodiment of the present invention;

FIG. 3 schematically illustrates a flowchart of a method for link adaptation in a precoded MIMO system according to one embodiment of the present invention;

FIG. 4 schematically illustrates a flowchart of a method for obtaining the HARQ scaling factor μᵣ with respect to at least one layer r according to one embodiment of the present invention; and

FIG. 5 schematically illustrates a block diagram of an apparatus for link adaptation in a precoded MIMO system according to one embodiment of the present invention.

### DETAILED DESCRIPTION OF EMBODIMENTS

Various embodiments of the present invention are described in detail with reference to the drawings. The flowcharts and block diagrams in the figures illustrate the apparatus, method, as well as architecture, functions and operations executable by a computer program product according to the embodiments of the present invention. In this regard, each block in the flowcharts or block diagram may represent a module, a program, or a part of code, which contains one or more executable instructions for performing specified logic functions. It should be noted that in some alternatives, functions indicated in blocks may occur in an order differing from the order as illustrated in the figures. For example, two blocks illustrated consecutively may be actually performed in parallel substantially or in an inverse order, which depends on related functions. It should also be noted that block diagrams and/or each block in the flowcharts and a combination of thereof may be implemented by a dedicated hardware-based system for performing specified functions/operations or by a combination of dedicated hardware and computer instructions.

In Table 1, terms used in the present invention are explained for clarity purpose.

TABLE 1
Terms

| No. | Terms | Descriptions |
|---|---|---|
| 1 | a^{H}, A^{H} | Conjugate transpose of a vector or matrix |
| 2 | ∥a∥, ∥A∥ | Vector 2-norm or matrix Frobenius norm |
| 3 | A[r, :] | The r^{th} row of matrix A |
| 4 | trA | Matrix trace operation |
| 5 | MIMO | Multiple-input multiple-output |
| 6 | LTE | Long Term Evolution |
| 7 | 3GPP | 3^{rd} generation partnership project |
| 8 | UE | User Equipment |
| 9 | eNB | Evolved Node B |
| 10 | MMSE | Minimum mean square error |
| 11 | SINR | Signal-to-interference and noise ratio |
| 12 | TDD | Time Division Duplex |
| 13 | CQI | Channel Quality Indicator |
| 14 | TM | Transmission Mode |
| 15 | CSI | Channel State Information |

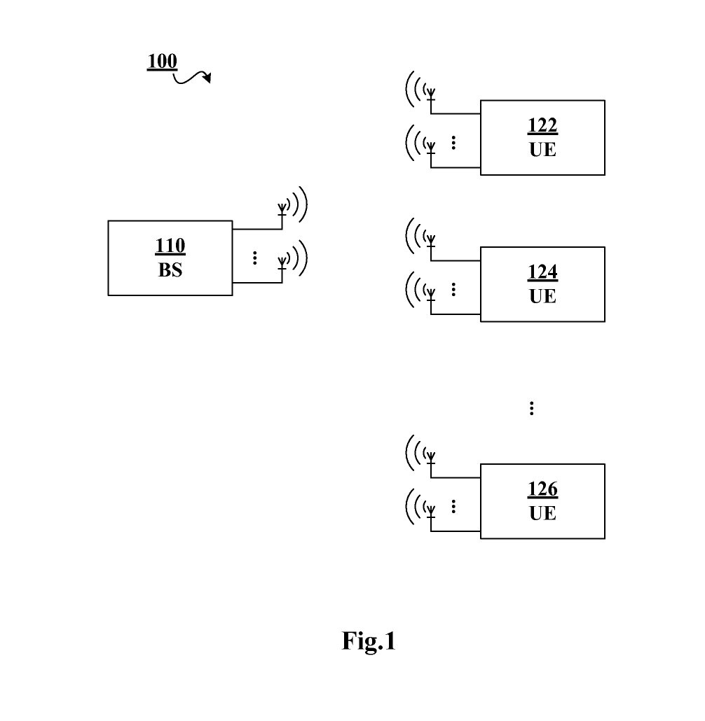

Referring to FIG. 1, which schematically illustrates a block diagram of a wireless communication system in which the methods and apparatuses of the present invention may be implemented. As illustrated in FIG. 1, the wireless communication system 100 may comprise a BS 110 and a plurality of UEs (UE 122, UE 124, . . . , and UE 126). Although only one BS 110 is illustrated in FIG. 1, those skilled in the art may contemplate that a number of BSes may present in the wireless communication system 100. The BS 101 may be equipped with M1 antennas for the purpose of transmitting and/or receiving data, and each of the UEs may also have a plurality of antennas (such as M2 antennas); wherein M1 and M2 are integers larger than 1. According to one embodiment of the present invention, the BS 110 may be an eNB. Hereinafter, various embodiments of the present invention will be schematically described in an environment composed of a plurality of eNBs and UEs. However, those skilled in the art may implement the methods and apparatus of the present invention in other wireless communication systems.

MIMO techniques have been widely employed in current wireless communication systems (e.g., LTE, WiMax etc.). And eigen-based precoded spatial multiplexing MIMO has already been adopted as a transmission scheme of TM8 in 3GPP LTE TDD. In eigen-based TM8 of LTE TDD, an eNB may determine eigen-beams for each layer based on uplink channel estimation by exploiting the channel reciprocity. The scheduling and link adaptation partially depend on the CQI feedback from the UE.

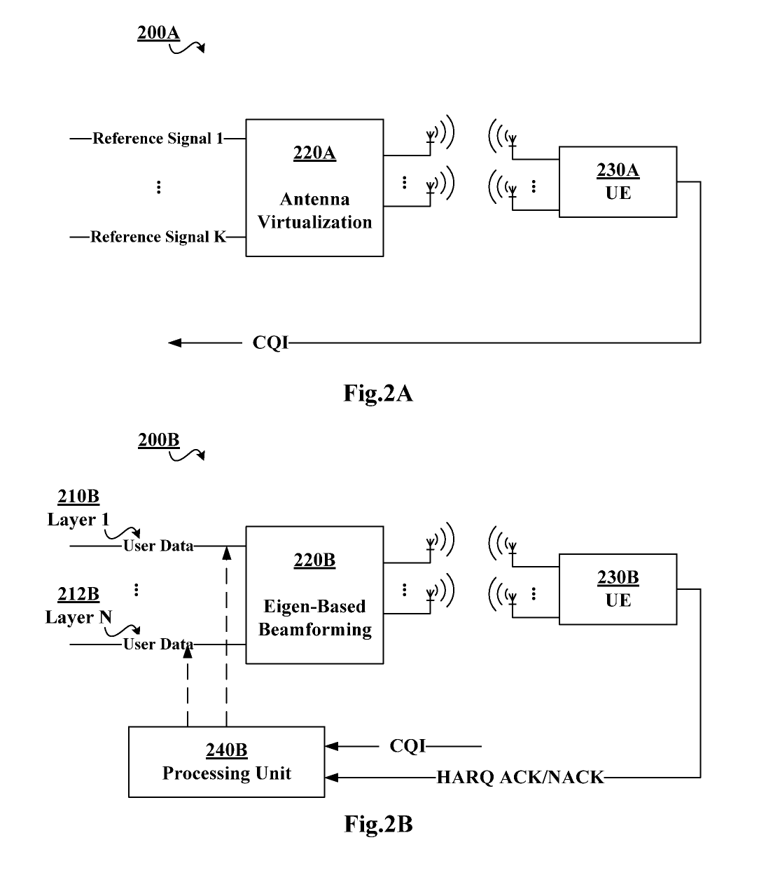

FIG. 2 schematically illustrates a block diagram of a typical CQI measurement. It is appreciated that CQI fed back from UE 230A is a measurement of the communication quality of wireless channels. Reference signals 1 . . . K are transmitted on a plurality of Layers so as to obtain the CQI feedback.

FIG. 2B schematically illustrates a block diagram of link adaptation according to one embodiment of the present invention. User data are transmitted on each one of Layer 1 210B to Layer N 212B. In the environment of the present invention, when eigen-based TM8 of LTE TDD is selected, it needs to determine the post equalization SINR for each layer based on the CQI feedback for purpose of scheduling and link adaptation. As illustrated in FIG. 2, processing unit 240B according to the present invention may read CQI feedback and HARQ ACK/NACK and then estimate the post equalization SINR for each layer (Layer 1 210B to Layer N 212B).

According to one embodiment of the present invention, there is provided a method for link adaptation in a precoded MIMO system. The method may comprise: receiving first channel quality information γ_{CQI}; with respect to at least one layer r in a plurality of layers in a link, obtaining a Hybrid Automatic Repeat Request (HARQ) scaling factor μᵣ that is associated with a HARQ feedback; and interpreting the first channel quality information γ_{CQI} into second channel quality information \hat{γ}ᵣ based on at least the HARQ scaling factor μᵣ, wherein the second channel quality information \hat{γ}ᵣ is for adapting the at least one layer r in the plurality of layers.

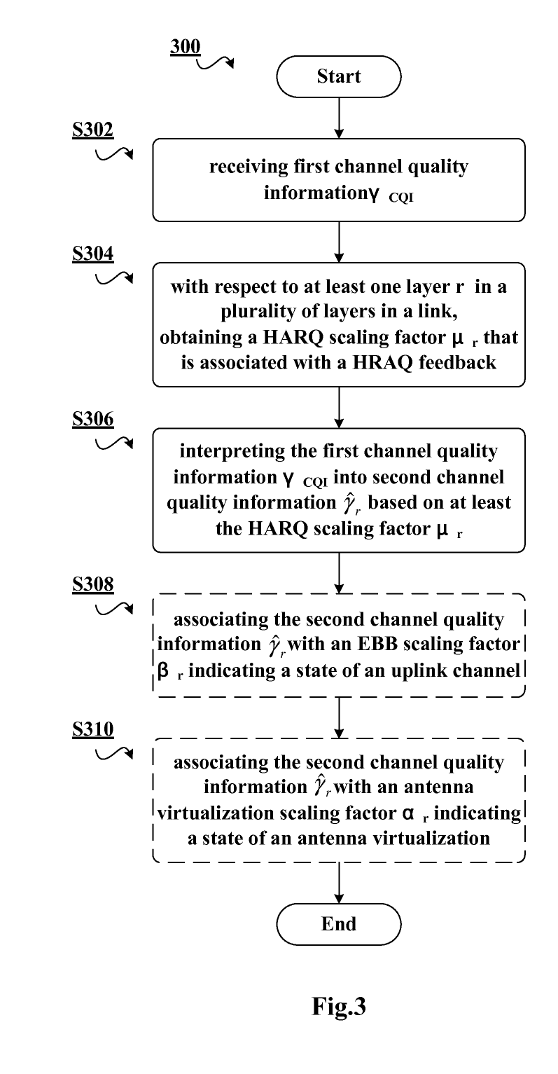

Referring to FIG. 3, which schematically illustrates a flowchart of a method for link adaptation in a precoded MIMO system according to one embodiment of the present invention. At block S302, first channel quality information γ_{CQI} is received from the UE. The first channel quality information γ_{CQI} may be of various formats, such as a Channel Quality Indicator with 4 bits as described in the above paragraph.

One purpose of the present invention is to provide the post equalization SINR for each individual layer based on the CQI feedback, accordingly, the below blocks S304 and S306 are performed with respect to each layer r. For example, layer r may represent one layer from N layers (Layer 1, . . . , Layer N), and r may be a value selected from a group of integers from 1 to N.

According to one embodiment of the present invention, Hybrid automatic repeat request (HARQ) is introduced into estimating the post equalization SINR for each layer. Those skilled in the art may appreciate that HARQ is a combination of high-rate forward error-correcting coding and ARQ error-control for detectable-but-uncorrectable errors. In standard ARQ, redundant bits are added to data to be transmitted using an error-detecting code such as cyclic redundancy check (CRC). In HARQ, a code is used that can perform both forward error correction (FEC) in addition to error detection (ED) (such as Reed-Solomon code or Turbo code), to correct a subset of all errors while relying on ARQ to correct errors that are uncorrectable using only the redundancy sent in the initial transmission. Typically, errors are checked at the UE end by an error detecting (such as CRC) code. If data pass the CRC, the UE sends an acknowledgement (ACK) for indicating successful transmission. If data do not pass the CRC, then the UE sends a negative acknowledgement (NACK) for requesting retransmission. Accordingly, an ACK/NACK may indicate whether data are successfully transmitted.

Based on meanings of HARQ feedback, the present invention proposes a method of calculating a HARQ scaling factor and uses this factor to scale the CQI as received in the block S302, such that a properly scaled value is provided to indicate further link adaptation with respect to each layer. At S304, with respect to at least one layer r in a plurality of layers in a link, a Hybrid Automatic Repeat Request (HARQ) scaling factor μᵣ that is associated with a HARQ feedback is obtained.

In the context of the present invention, the HARQ feedback may be divided into a single-layer HARQ feedback and a multi-layers HARQ feedback. Accordingly, in one embodiment of the present invention, the HARQ scaling factor μᵣ for layer r is adjusted according to whether a single-layer HARQ feedback or a multi-layers HARQ feedback is received.

At S306, the first channel quality information γ_{CQI} is interpreted into second channel quality information \hat{γ}ᵣ based on at least the HARQ scaling factor μᵣ, wherein the second channel quality information \hat{γ}ᵣ is for adapting the at least one layer r in the plurality of layers.

Hereinafter, details in adjusting the HARQ scaling factor μᵣ are described with reference to various embodiments of the present invention. Although the prior art has disclosed methods of evaluating CQI scaling factor from HARQ ACK/NACK feedbacks, those methods are suitable for only single layer environment, but fail to provide correct evaluation when being used in a multiple layers environment.

According to one embodiment of the present invention, the obtaining the HARQ scaling factor μᵣ that is associated with a HARQ feedback comprises: adjusting the HARQ scaling factor μᵣ for everyone in the plurality of layers in response to a single-layer HARQ feedback being received; and adjusting the HARQ scaling factor μᵣ only for layer r on which a multi-layers HARQ feedback is received in response to the multi-layers HARQ feedback being received.

Those skilled in the art may appreciate that single-layer transmission and/or multi-layers transmission may be used in the wireless communication system. Thus, the single-layer/multi-layers HARQ feedback may affect the HARQ scaling factor μᵣ for different layers. Further, there exist ACK/NACK for single-layer transmission and ACK/NACK for multi-layers transmission. The ACK/NACK determines whether the HARQ scaling factor should be increased or decreased.

According to one embodiment of the present invention, the adjusting the HARQ scaling factor μᵣ for everyone in the plurality of layers in response to a single-layer HARQ feedback being received comprises: increasing the HARQ scaling factor μᵣ for everyone in the plurality of layers in response to a single-layer HARQ ACK being received; and decreasing the HARQ scaling factor μᵣ for everyone in the plurality of layers in response to a single-layer HARQ NACK being received.

According to one embodiment of the present invention, the adjusting the HARQ scaling factor μᵣ only for layer r on which a multi-layers HARQ feedback is received in response to the multi-layers HARQ feedback being received comprises: increasing the HARQ scaling factor μᵣ only for layer r on which a multi-layers HARQ ACK is received in response to the multi-layers HARQ ACK being received; and decreasing the HARQ scaling factor μᵣ only for layer r on which a multi-layers HARQ NACK is received in response to the multi-layers HARQ NACK being received.

With respect to each layer r in the plurality of layers (such as Layer 1, . . . , Layer N as illustrated in FIG. 2), if an ACK is received for the single-layer transmission, then the HARQ scaling factor μᵣ (r=1 . . . N) is increased; if an ACK is received for the multi-layers transmission, then only the HARQ scaling factor μᵣ for layer r on which the ACK is received is increased while the HARQ scaling factor μₛ for other layer s (s≠r) remains untouched. As for a NACK feedback, with respect to each layer r in the plurality of layers (such as Layer 1 . . . Layer N as illustrated in FIG. 2), if a NACK is received for the single-layer transmission, then the HARQ scaling factor μᵣ (r=1 . . . N) is decreased; if a NACK is received for the multi-layers transmission, then only the HARQ scaling factor μᵣ for layer r on which the NACK is received is decreased while the HARQ scaling factor μₛ for other layer s (s≠r) remains untouched. In the method of calculating the HARQ scaling factor μᵣ, different steps may be used in the increasing and decreasing operations.

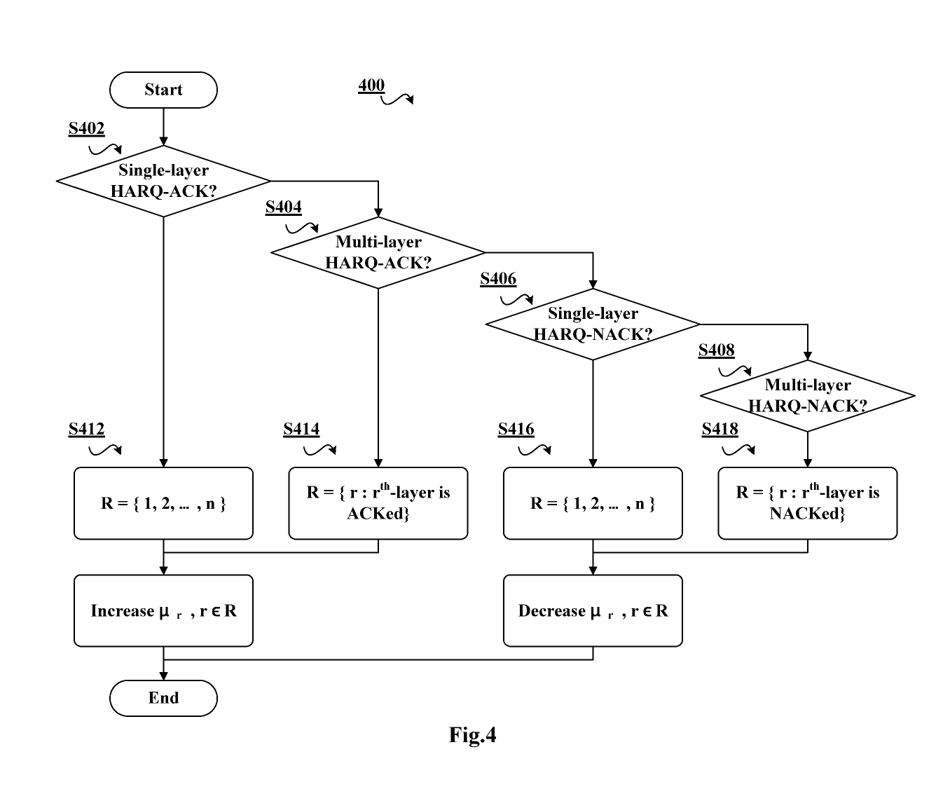

As for details in obtaining the HARQ scaling factor μᵣ that is associated with a HARQ feedback, reference will be made to FIG. 4. FIG. 4 schematically illustrates a flowchart of a method for obtaining the HARQ scaling factor μᵣ with respect to at least one layer r according to one embodiment of the present invention. In the embodiment as illustrated in FIG. 4, the flow starts at block S402 where a type of the HARQ feedback is determined. Regarding the type of the HARQ feedback, it involves two respects, one respect relates to whether data transmission is successful or not (i.e., whether an ACK or a NACK is received), the other respect relates to whether the current HARQ feedback is for the single-layer transmission or for the multi-layers transmission. Accordingly, one HARQ feedback may be classified into four types: Single-layer HARQ ACK, Multi-layers HARQ ACK, Single-layer HARQ NACK and Multi-layers HARQ NACK. In FIG. 4, each of the above four types corresponds to one branch, respectively.

Taking the first branch (blocks S402 and S412) as an example, if it is determined at block S402 that the HARQ feedback is a single-layer HARQ ACK, then the flow proceeds to block S412. And then at block S412, the HARQ scaling factor μᵣ for each layer r (r=1 . . . N) is increased. Next, the flow proceeds to the “End” block.

In the second branch (blocks S404 and S414), if it is determined at block S404 that the HARQ feedback is a multi-layers HARQ ACK, then the flow proceeds to block S414, at this block, only the HARQ scaling factor μᵣ for layer r on which the ACK is received is increased while the HARQ scaling factor μₛ for other layer s (s≠r) remains untouched. Next, the flow proceeds to the “End” block. Form the flowchart as illustrated in FIG. 4, those skilled in the art may obtain the HARQ scaling factor μᵣ for each layer r in the plurality of Layers 1 . . . N. Details of other branches such as S406 and S408 are omitted hereinafter.

According to one embodiment of the present invention, the obtaining a Hybrid Automatic Repeat Request (HARQ) scaling factor μᵣ that is associated with a HARQ feedback may be performed in different ways. Specifically, two modes are provided for calculating the HARQ scaling factor μᵣ, wherein a lower bound-based mode may be applied in a situation that a conservative compensation on the reported CQI has been adopted, hence, the previous scaling factor is relatively small and should be increased quickly; and an upper bound-based mode may be applied in a situation that an aggressive modification on the reported CQI has been employed, thus the previous scaling factor is relatively large and should be decrease quickly.

According to one embodiment of the present invention, once the method is started in one mode, it cannot be switched to the other. To be simple, “Δ” is used for indicating step sizes in decibels in the increasing and decreasing operations.

In the lower bound-based mode:
1. If an ACK/NACK is received for the single-layer transmission, then

$${Δ}_{r} = \{ \begin{matrix}0.5 , & ACK \\ 0.05 , & NACK\end{matrix} \\ wherein , r = 1 … N ; \qquad ( Formula 1 )$$

2. If an ACK/NACK is received for the r^{th} layer in the multi-layers transmission, then

$${Δ}_{r} = \{ \begin{matrix}0.5 , & ACK \\ 0.05 , & NACK\end{matrix} , \\ the {r}^{th} layer on which the ACK / NACK is received ; \qquad ( Formula 2 )$$

$${Δ}_{s} = \{ \begin{matrix}0 , & ACK \\ 0 , & NACK\end{matrix} \\ wherein , s \neq r ; \qquad ( Formula 3 )$$

From the previous description, those skilled in the art may understand meanings of the above formulas. Taking Formula 1 as an example, it indicates that for each layer r in the plurality of Layers 1 . . . N, in response to an ACK being received, the step in the increasing operation is 0.5; and in response to a NACK being received, the step in the decreasing operation is 0.05.

In the upper bound-based mode:
1. If an ACK/NACK is received for the single-layer transmission, then

$${Δ}_{r} = \{ \begin{matrix}0.05 , & ACK \\ 0.5 , & NACK\end{matrix} \\ wherein , r = 1 … N ; \qquad ( Formula 4 )$$

2. If an ACK/NACK is received for the r^{th} layer in the multi-layers transmission, then

$$\begin{matrix} {Δ}_{r} = \{ \begin{matrix}0.05 , & ACK \\ 0.5 , & NACK\end{matrix} , \\ the {r}^{th} layer on which the ACK / NACK is received ; & ( Formula 5 ) \\ {Δ}_{s} = \{ \begin{matrix}0 , & ACK \\ 0 , & NACK\end{matrix} \\ wherein , s \neq r . & ( Formula 6 )\end{matrix}$$

In view of the above, those skilled in the art may understand meanings of Formulas 2 to 6. Further, it is appreciated that specific values as illustrated in the above Formulas 1 to 6 are only for schematic purpose. And those skilled in the art may consider any other values in calculating the HARQ scaling factor μᵣ.

According to one embodiment of the present invention, the method for link adaptation in a precoded MIMO system further comprising: associating the second channel quality information \hat{γ}ᵣ with an Eigen-based Beamforming (EBB) scaling factor βᵣ indicating a state of an uplink channel.

Referring back to FIG. 3, the blocks S302-S308 illustrate a further method for link adaptation in the precoded MIMO system, wherein both the HARQ scaling factor μᵣ and the EBB scaling factor βᵣ are involved in generating the second channel quality information \hat{γ}ᵣ. The blocks S302-S306 are identical to the above descriptions, and only block S308 is detailed here for simplicity. Block S308 illustrated in dotted line represents the step of associating the second channel quality information \hat{γ}ᵣ with the EBB scaling factor βᵣ indicating the state of the uplink channel.

In this embodiment, the EBB scaling factor βᵣ may be considered in scaling the CQI received from the UE. For example, the EBB scaling factor may be determined as below:

$${β}_{r} = \frac{{λ}_{r}}{{‖ {HW}_{v} ‖}^{2}} \qquad ( Formula 7 )$$

Wherein H^{T} is an estimated uplink channel, λᵣ is the r^{th} ordered eigenvalue of HH^{T}; and Wᵥ is an antenna virtualization precoding matrix.

According to one embodiment of the present invention, the method for link adaptation in a precoded MIMO system further comprising: associating the second channel quality information \hat{γ}ᵣ with an antenna virtualization scaling factor αᵣ indicating a state of an antenna virtualization. As antenna virtualization is performed at the eNB, accordingly, effects imposed by the antenna virtualization should be considered in scaling the CQI received from the UE.

Referring back to FIG. 3, the blocks S302-S310 illustrate a further method for link adaptation in the precoded MIMO system, wherein the HARQ scaling factor μᵣ, the EBB scaling factor βᵣ and the antenna virtualization scaling factor αᵣ are involved in generating the second channel quality information \hat{γ}ᵣ. The blocks S302-S308 are identical to the above descriptions, and only block S310 is detailed here for simplicity. Block S310 illustrated in dotted line represents the step of associating the second channel quality information \hat{γ}ᵣ with the antenna virtualization scaling factor αᵣ indicating the state of the antenna virtualization.

According to one embodiment of the present invention, the HARQ scaling factor μᵣ is relevant to the antenna virtualization scaling factor αᵣ. According to the above descriptions, the obtaining the HARQ scaling factor μᵣ that is associated with a HARQ feedback is performed in the lower bound-based mode or the upper bound-based mode. With respect to different modes, the method of calculating αᵣ varies. In other words, the calculations of αᵣ and μᵣ are correlated with each other.

According to one embodiment of the present invention, the antenna virtualization scaling factor αᵣ may be calculated as below:

In the lower bound-based mode:

$${α}_{r} = \frac{{λ}_{2}^{′}}{{‖ {HW}_{v} ‖}_{F}^{2}} ( r = 1 … N ) \qquad ( Formula 8 )$$

wherein \dot{λ}₂ is the smallest eigenvalue of (HWᵥ)(HWᵥ)^{H}.

In the upper bound-based mode:

αᵣ=cᵣ(r=1 . . . N) (Formula 9)

wherein cᵣ is a constant value.

It is appreciate that the constant values cᵣ for respective layers may be assigned to different values or they be defined with the same value. For example, according to one embodiment of the present invention, the factor cᵣ for each layer r may be set to 1, which is an upper bound value. However, considering specific states of each layer r, the antenna virtualization scaling factor αᵣ may be set to different constant values.

According to one embodiment of the present invention, in the lower bound-based mode, Formulas 1-3 may be used for calculating the HARQ scaling factor μᵣ and Formula 8 may be used for calculating the antenna virtualization scaling factor αᵣ; in the upper bound-based mode Formulas 4-7 may be used for calculating the HARQ scaling factor μᵣ and Formula 9 may be used for calculating the antenna virtualization scaling factor αᵣ.

In view of the above, several factors may be considered in generating the second channel quality information \hat{γ}ᵣ. For example, the HARQ scaling factor μᵣ may be individually used in generating the second channel quality information \hat{γ}ᵣ, or both the HARQ scaling factor μᵣ and the EBB scaling factor βᵣ may be considered in generating the second channel quality information \hat{γ}ᵣ. According to one embodiment of the present invention, the HARQ scaling factor μᵣ, the EBB scaling factor βᵣ and the antenna virtualization scaling factor αᵣ are applied to generate the second channel quality information \hat{γ}ᵣ. In this case, with respect to at least one layer r in a plurality of layers in a link, \hat{γ}ᵣ=αᵣ·βᵣ·μᵣ·γ_{CQI}.

According to one embodiment of the present invention, the first channel quality information γ_{CQI} may be represented by a Channel Quality Indicator and the second channel quality information \hat{γ}ᵣ may be represented in form of signal to interference plus noise power ratio SINR.

According to one embodiment of the present invention, the step of receiving first channel quality information γ_{CQI} may be performed periodically, for example, it may be triggered at predefined intervals. Alternatively, this receiving step may be performed in response to certain events as desired according to specific configurations in various wireless communication systems.

According to one embodiment of the present invention, the steps as illustrated in FIG. 3 may be implemented at the eNB end.

Table 2 schematically illustrates a comparison between solutions of the prior art and the present invention. It is appreciated that the present invention may achieve better effects.

TABLE 2
A comparison between the prior art and the present invention

| | Cell Average Spectral | Cell Edge User |
|---|---|---|
| Solutions | Efficiency [b/s/Hz] | Throughput [b/s/Hz] |
| The prior art | 2.75 (—) | 0.104 (—) |
| The present invention | 2.94 (+6.9%) | 0.105 (+1.0%) |

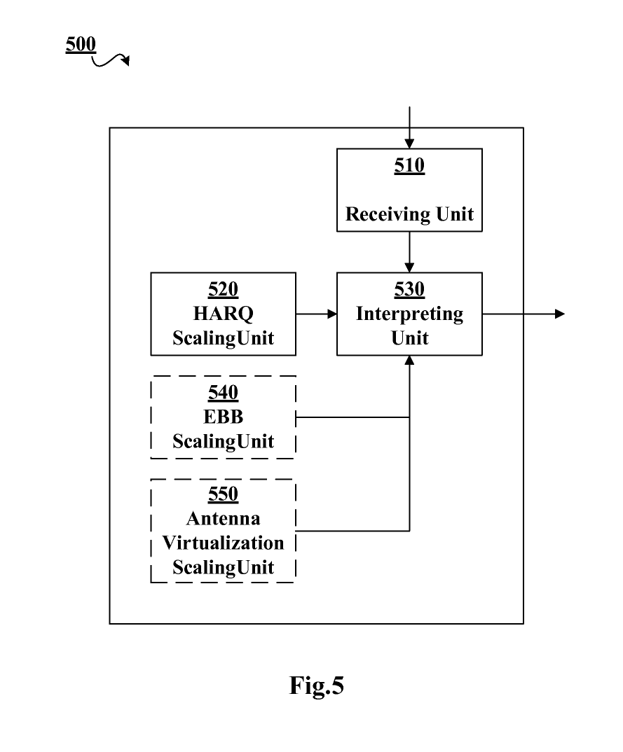

According to one embodiment of the present invention, there is provided an apparatus for link adaptation in a precoded MIMO system. FIG. 5 schematically illustrates a block diagram of an apparatus for link adaptation in a precoded MIMO system according to one embodiment of the present invention. In FIG. 5, the apparatus 500 may comprise: a receiving unit 510 configured for receiving first channel quality information γ_{CQI}; an HARQ scaling unit 520 configured for, with respect to at least one layer r in a plurality of layers in a link, obtaining a Hybrid Automatic Repeat Request (HARQ) scaling factor μᵣ that is associated with a HARQ feedback; and an interpreting unit 530 configured for, with respect to at least one layer r in a plurality of layers in a link, interpreting the first channel quality information γ_{CQI} into second channel quality information \hat{γ}ᵣ based on at least the HARQ scaling factor μᵣ, wherein the second channel quality information \hat{γ}ᵣ is for adapting the at least one layer r in the plurality of layers.

In FIG. 5, an EBB scaling unit 540 and an antenna virtualization scaling unit 550 are illustrated in dotted blocks, which indicate that the EBB scaling unit 540 and the antenna virtualization scaling unit 550 may be present in or absent from the apparatus 500. In other words, these units 540 and 550 are optional units of the apparatus 500 and the apparatus may be implemented without one or more of these units.

According to one embodiment of the present invention, the HARQ scaling unit 520 may comprise: a first adjusting unit configured for adjusting the HARQ scaling factor μᵣ for everyone in the plurality of layers in response to a single-layer HARQ feedback being received; and a second adjusting unit configured for adjusting the HARQ scaling factor μᵣ only for layer r on which a multi-layers HARQ feedback is received in response to the multi-layers HARQ feedback being received.

According to one embodiment of the present invention, the first adjusting unit comprises: a first increasing unit configured for increasing the HARQ scaling factor μᵣ for everyone in the plurality of layers in response to a single-layer HARQ ACK being received; and a first decreasing unit configured for decreasing the HARQ scaling factor μᵣ for everyone in the plurality of layers in response to a single-layer HARQ NACK being received.

According to one embodiment of the present invention, the second adjusting unit comprises: a second increasing unit configured for increasing the HARQ scaling factor μᵣ only for layer r on which a multi-layers HARQ ACK is received in response to the multi-layers HARQ ACK being received; and a second decreasing unit configured for decreasing the HARQ scaling factor μᵣ only for layer r on which a multi-layers HARQ NACK is received in response to the multi-layers HARQ NACK being received.

According to one embodiment of the present invention, the HARQ scaling unit 520 may be further configured to a lower bound-based mode or an upper bound-based mode.

According to one embodiment of the present invention, the apparatus may further comprise: an EBB scaling unit 540 configured for associating the second channel quality information \hat{γ}ᵣ with an Eigen-based Beamforming (EBB) scaling factor βᵣ indicating a state of an uplink channel.

According to one embodiment of the present invention, the EBB scaling factor

$${β}_{r} = \frac{{λ}_{r}}{{‖ {HW}_{v} ‖}^{2}} ,$$

H^{T} is an estimated uplink channel, λᵣ is the r^{th} ordered eigenvalue of HH^{T}; and Wᵥ is an antenna virtualization precoding matrix.

According to one embodiment of the present invention, the apparatus may further comprise an antenna virtualization scaling unit 550 configured for associating the second channel quality information \hat{γ}ᵣ with an antenna virtualization scaling factor αᵣ indicating a state of an antenna virtualization.

According to one embodiment of the present invention, the HARQ scaling factor μᵣ is relevant to the antenna virtualization scaling factor αᵣ.

According to one embodiment of the present invention, the antenna virtualization scaling factor

$${α}_{r} = \{ \begin{matrix}\frac{{λ}_{2}^{′}}{{‖ {HW}_{v} ‖}_{F}^{2}} , & \begin{matrix}{λ}_{2}^{′} is the smallest eigenvalue of ( {HW}_{v } ) \\ {( {HW}_{v} )}^{H} ( in the lower bound \text{-} based mode )\end{matrix} \\ 1 , & ( in the upper bound \text{-} based mode )\end{matrix}$$

According to one embodiment of the present invention, \hat{γ}ᵣ=αᵣ·βᵣ·μᵣ·γ_{CQI}.

According to one embodiment of the present invention, there is provided a computer-readable storage medium having executable computer-readable program code instructions stored therein, the instructions enable a data processing device to implement the methods as described in the present invention.

According to the disclosure in describing the method for link adaptation in a precoded MIMO system, those skilled in the art would achieve the apparatuses and computer-readable storage medium for implementing the methods as described in the present invention.

Based on the above description, the skilled in the art would appreciate that the present invention may be embodied in an apparatus, a method, or a computer program product. Thus, the present invention may be specifically implemented in the following manners, i.e., complete hardware, complete software (including firmware, resident software, microcode, etc), or a combination of software part and hardware part as generally called “circuit,” “module,” or “system” herein. Further, the present invention may also adopt a form of computer program product as embodied in any tangible medium of expression, the medium comprising computer-usable program code.

Any combination of one or more computer-usable or computer-readable mediums may be used. The computer-usable or computer-readable medium may be for example, but not limited to, electrical, magnetic, optical, electromagnetic, infrared, or semiconductor system, means, device, or propagation medium. More specific examples (non-exhaustive list) of the computer-readable medium comprise: an electric connection having one or more leads, a portable computer magnetic disk, hard disk, random access memory (RAM), read-only memory (ROM), erasable programmable read-only memory (EPROM or flash), optical fiber, portable compact disk read-only memory (CD-ROM), optical storage device, a transmission medium for example, supporting internet or intranet, or a magnetic storage device. It should be noted that the computer-usable or computer readable medium may even be a paper printed with a program thereon or other suitable medium, because the program may be obtained electronically by electrically scanning such paper or other medium, and then compiled, interpreted or processed in a suitable manner, and if necessary, stored in a computer memory. In the context of the present document, a computer-usable or computer-readable medium may be any medium containing, storing, communicating, propagating, or transmitting a program available for an instruction execution system, apparatus or device, or associated with the instruction execution system, apparatus, or device. A computer-usable medium may comprise a data signal contained in a base band or propagated as a part of carrier and embodying a computer-usable program code. A computer-usable program code may be transmitted by any suitable medium, including, but not limited to, radio, wire, cable, or RF, etc.

A computer program code for executing operations of the present invention may be written by any combination of one or more program design languages, the program design languages including object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, including local area network (LAN) or wide area network (WAN), or connected to external computer (for example, by means of an internet service provider via Internet).

Further, each block in the flowcharts and/or block diagrams of the present invention and combination of respective blocks therein may be implemented by computer program instructions. These computer program instructions may be provided to a processor of a general purpose computer, a dedicated computer or other programmable data processing apparatus, thereby generating a machine such that these instructions executed through the computer or other programmable data processing apparatus generate means for implementing functions/operations prescribed in the blocks of the flowcharts and/or block diagrams.

These computer program instructions may also be stored in a computer-readable medium capable of instructing the computer or other programmable data processing apparatus to work in a particular manner, such that the instructions stored in the computer-readable medium generate a product including instruction means for implementing the functions/operations prescribed in the flowcharts and/or block diagrams.

The computer program instructions may also be loaded on a computer or other programmable data processing apparatus, such that a series of operation steps are implemented on the computer or other programmable data processing apparatus, to generate a computer-implemented process, such that execution of the instructions on the computer or other programmable apparatus provides a process of implementing the functions/operations prescribed in the blocks of the flowcharts and/or block diagrams.

Though the exemplary embodiments of the present invention are described herein with reference to the drawings, it should be understood that the present invention is not limited to these accurate embodiments, and a person of normal skill in the art can make various modifications to the embodiments without departing from the scope and principle of the present invention. All such variations and modifications are intended to be included in the scope of the present invention as defined in the appended claims.

1. A method for link adaptation in a precoded MIMO system, comprising:
receiving first channel quality information γ_{CQI};
with respect to at least one layer r in a plurality of layers in a link,
obtaining a Hybrid Automatic Repeat Request (HARQ) scaling factor μᵣ that is associated with a HARQ feedback; and
interpreting the first channel quality information γ_{CQI} into second channel quality information \hat{γ}ᵣ based on at least the HARQ scaling factor μᵣ, wherein the second channel quality information \hat{γ}ᵣ is for adapting the at least one layer r in the plurality of layers.

2. The method of claim 1, wherein the obtaining the HARQ scaling factor μᵣ that is associated with a HARQ feedback comprises:
adjusting the HARQ scaling factor μᵣ for everyone in the plurality of layers in response to a single-layer HARQ feedback being received; and
adjusting the HARQ scaling factor μᵣ only for layer r on which a multi-layers HARQ feedback is received in response to the multi-layers HARQ feedback being received.

3. The method of claim 2, wherein the adjusting the HARQ scaling factor μᵣ for everyone in the plurality of layers in response to a single-layer HARQ feedback being received comprises:
increasing the HARQ scaling factor μᵣ for everyone in the plurality of layers in response to a single-layer HARQ ACK being received; and
decreasing the HARQ scaling factor μᵣ for everyone in the plurality of layers in response to a single-layer HARQ NACK being received.

4. The method of claim 2, wherein adjusting the HARQ scaling factor μᵣ only for layer r on which a multi-layers HARQ feedback is received in response to the multi-layers HARQ feedback being received comprises:
increasing the HARQ scaling factor μᵣ only for layer r on which a multi-layers HARQ ACK is received in response to the multi-layers HARQ ACK being received; and
decreasing the HARQ scaling factor μᵣ only for layer r on which a multi-layers HARQ NACK is received in response to the multi-layers HARQ NACK being received.

5. The method of claim 1, wherein the obtaining a Hybrid Automatic Repeat Request (HARQ) scaling factor μᵣ that is associated with a HARQ feedback is performed in a lower bound-based mode or an upper bound-based mode.

6. The method of claim 5, further comprising: associating the second channel quality information \hat{γ}ᵣ with an Eigen-based Beamforming (EBB) scaling factor βᵣ indicating a state of an uplink channel.

7. The method of claim 6, wherein the EBB scaling factor
$${β}_{r} = \frac{{λ}_{r}}{{‖ {HW}_{v} ‖}^{2}} ,$$
H^{T} is an estimated uplink channel, λᵣ is the r^{th} ordered eigenvalue of HH^{T}; and Wᵥ is an antenna virtualization precoding matrix.

8. The method of claim 7, further comprising: associating the second channel quality information \hat{γ}ᵣ with an antenna virtualization scaling factor αᵣ indicating a state of an antenna virtualization.

9. The method of claim 8, wherein the HARQ scaling factor μᵣ is relevant to the antenna virtualization scaling factor αᵣ.

10. The method of claim 9, wherein the antenna virtualization scaling factor
$${α}_{r} = \{ \begin{matrix}\frac{{λ}_{2}^{′}}{{‖ {HW}_{v} ‖}_{F}^{2}} , & \begin{matrix}{λ}_{2}^{′} is the smallest eigenvalue of ( {HW}_{v } ) \\ {( {HW}_{v} )}^{H} ( in the lower bound \text{-} based mode )\end{matrix} \\ 1 , & ( in the upper bound \text{-} based mode )\end{matrix} .$$

11. The method of claim 10, wherein \hat{γ}ᵣ=αᵣ·βᵣ·μᵣ·γ_{CQI}.

12. An apparatus for link adaptation in a precoded MIMO system, comprising:
a receiving unit configured for receiving first channel quality information γ_{CQI};
an obtaining unit configured for, with respect to at least one layer r in a plurality of layers in a link, obtaining a Hybrid Automatic Repeat Request (HARQ) scaling factor μᵣ that is associated with a HARQ feedback; and
an interpreting unit configured for, with respect to at least one layer r in a plurality of layers in a link, interpreting the first channel quality information γ_{CQI} into second channel quality information \hat{γ}ᵣ based on at least the HARQ scaling factor μᵣ, wherein the second channel quality information \hat{γ}ᵣ is for adapting the at least one layer r in the plurality of layers.

13. The apparatus of claim 12, wherein the obtaining unit comprises:
a first adjusting unit configured for adjusting the HARQ scaling factor μᵣ for everyone in the plurality of layers in response to a single-layer HARQ feedback being received; and
a second adjusting unit configured for adjusting the HARQ scaling factor μᵣ only for layer r on which a multi-layers HARQ feedback is received in response to the multi-layers HARQ feedback being received.

14. The apparatus of claim 13, wherein the first adjusting unit comprises:
a first increasing unit configured for increasing the HARQ scaling factor μᵣ for everyone in the plurality of layers in response to a single-layer HARQ ACK being received; and
a first decreasing unit configured for decreasing the HARQ scaling factor μᵣ for everyone in the plurality of layers in response to a single-layer HARQ NACK being received.

15. The apparatus of claim 13, wherein the second adjusting unit comprises:
a second increasing unit configured for increasing the HARQ scaling factor μᵣ only for layer r on which a multi-layers HARQ ACK is received in response to the multi-layers HARQ ACK being received; and
a second decreasing unit configured for decreasing the HARQ scaling factor μᵣ only for layer r on which a multi-layers HARQ NACK is received in response to the multi-layers HARQ NACK being received.

16. The apparatus of claim 12, wherein the obtaining unit is further configured to a lower bound-based mode or an upper bound-based mode.

17. The apparatus of claim 16, further comprising: a first associating unit configured for associating the second channel quality information \hat{γ}ᵣ with an Eigen-based Beamforming (EBB) scaling factor βᵣ indicating a state of an uplink channel.

18. The apparatus of claim 17, wherein the EBB scaling factor
$${β}_{r} = \frac{{λ}_{r}}{{‖ {HW}_{v} ‖}^{2}} ,$$
H^{T} is an estimated uplink channel, λᵣ is the r^{th} ordered eigenvalue of HH^{T}; and Wᵥ is an antenna virtualization precoding matrix.

19. The apparatus of claim 18, further comprising: a second associating unit configured for associating the second channel quality information \hat{γ}ᵣ with an antenna virtualization scaling factor αᵣ indicating a state of an antenna virtualization.

20. The apparatus of claim 19, wherein the HARQ scaling factor μᵣ is relevant to the antenna virtualization scaling factor αᵣ.

21. The apparatus of claim 20, wherein the antenna virtualization scaling factor
$${α}_{r} = \{ \begin{matrix}\frac{{λ}_{2}^{′}}{{‖ {HW}_{v} ‖}_{F}^{2}} , & \begin{matrix}{λ}_{2}^{′} is the smallest eigenvalue of ( {HW}_{v } ) \\ {( {HW}_{v} )}^{H} ( in the lower bound \text{-} based mode )\end{matrix} \\ 1 , & ( in the upper bound \text{-} based mode )\end{matrix} .$$

22. The apparatus of claim 21, wherein \hat{γ}ᵣ=αᵣ·βᵣ·μᵣ·γ_{CQI}.

23. A computer-readable storage medium having executable computer-readable program code instructions stored therein, the instructions enable a data processing device to implement the methods as claimed in claim 1.
